(19) United States
(12) Patent Application Publication
(10) Pub. No.: US 2002/0005019 A1
(43) Pub. Date: Jan. 17, 2002

(54) Directional light for office spaces

(76) Inventors: Richard Trilli, Holland, MI (US); Rick Perkins, Holland, MI (US); Charles Saylor, Grand Rapids, MI (US)

Correspondence Address: FLYNN, THIEL, BOUTELL & TANIS, P.C., 2026 Rambling Road, Kalamazoo, MI, 49008-1699, US

(21) Appl. No.: 09/858,863

(22) Filed: May 16, 2001

Related U.S. Application Data
(60) Provisional application No. 60/204,478, filed on May 16, 2000.

(51) Int. Cl. E04H 1/00; A47F 10/00; E04B 2/74; A47B 23/06; F21V 33/00; A47B 97/00; F21S 8/00; F21S 4/00

(52) U.S. Cl. 52/36.1; 52/36.5; 362/223; 362/225; 362/127; 362/132; 362/133; 362/145; 362/147

(57) ABSTRACT

A system of directional lights for use in office spaces, wherein each of individual directional lights is adapted to be plugged into electrical outlets and has a selectable directional indicator. The directional light has light transmitting windows in its front face which selectively transmit light to indicate a select direction. The directional lights thereby are portable and reconfigurable, and are mounted throughout an office area to direct occupants to a destination such as an exit or conference room.

### CROSS REFERENCE TO RELATED APPLICATION

This application claims the benefit of U.S. Provisional Application No. 60/204,478, filed May 16, 2000.

### FIELD OF THE INVENTION

This invention relates to a directional light for indicating direction, and more particularly to a directional light for use in office spaces.

### BACKGROUND OF THE INVENTION

Modern office environments are many times constructed from modular space dividing structures, for example, upright wall panels. The assignee of the present application, Haworth Inc., manufactures such wall panel systems. Examples of wall panels which are connected to form a wall panel system can be found in U.S. Pat. Nos. 3,990,204, 4,060,294, 4,199,206, 4,367,370, 5,377,466, 5,606,919, 5,806,258, 5,852,904, all of which are herein incorporated by reference.

Typically, wall panels are joined serially or at angled joints to divide a large space into smaller, individual work stations which are joined together by passages. These wall panel systems provide a more flexible alternative to multi-passage offices having conventional stud walls. Such wall panels can include other furniture components, and preferably include raceways that supply electricity throughout the work spaces and have electrical receptacles with standard three-prong electrical outlets.

The wall panels are configurable into a plurality of different layouts to meet the needs of the particular business, and can be reconfigured to alter the floor plan of the work spaces. When reconfiguring wall panels, the arrangement of work stations, passages and passage intersections as well as the location of electrical receptacles often change. For new employees and visitors who are unfamiliar with an office layout, difficulties may be encountered in locating an exit or meeting site. Difficulties also may be encountered after an office is reconfigured. Thus, there is a need in office environments to provide directions to direct people through these passages and intersections to desired locations, for example exits and conference rooms.

Illuminated signs are typically provided in commercial office buildings to identify the location of exits. Such lights are fixed to the wall or ceiling adjacent the exit with an illuminated directional arrow pointing toward the exit and with the word “exit” illuminated. The lights are hardwired to the building electrical system and thus, are not mobile. While these exit indicator lights are useful and are usually mandated by building codes, they perform the very specific function of indicating the location of an exit at a fixed location directly adjacent to a door. As a result, these signs provide little assistance in leading occupants through multiple passages to the exit.

Additional hardwired systems are known for directing occupants to an exit. These more complex systems have elongated indicator rails or cables which mount to building walls and start a significant distance from a door to lead an occupant to the door typically during emergencies. These systems, however, are not readily reconfigurable and have limited flexibility.

Lights that plug into standard electrical outlets are known, for example, night lights, personal safety lights and emergency lights. Examples can be found in U.S. Pat. Nos. 5,146,209 and 5,633,623. While these lights obviously provide light, they do not provide directional indicators to direct people to a specific destination, for example an exit or a specific room.

In view of the foregoing, it is an object of the present invention to provide a system of portable lights that is adaptable with multi-passage offices and modern office systems and provides direction indicators where needed in the office. It is a further object of the present invention to provide a directional light that is easily movable and has a direction indicator that is easily changed.

### SUMMARY OF THE INVENTION

The present invention is directed to a directional light or indicator unit, which can plug into a conventional three-prong electrical outlet to power the light and has a housing with a front face that provides a directional indicator such as a lighted arrow. In use, a system of one or more of these directional lights are mounted to existing permanent walls or movable wall panels wherein the directional lights are placed, for example, along passageways or at passage intersections to direct an occupant to an exit door or other destination.

The direction of the indicator is easily selected so that the light is configurable to the specific office layout in which it is used. Further, the directional light preferably plugs into existing receptacles and therefore is readily portable. Accordingly, the directional light can be used in current offices without remodeling. That is, the business being conducted need not be interrupted by electricians using power tools to mount the directional light to a ceiling or wall or stringing new electrical wire through the office.

In one embodiment of the invention, each directional light can indicate a plurality of directions. The directional light has a user actuated switch that selectively energizes one or more lights which indicate a selected direction.

In another embodiment of the present invention, the directional light has windows or leg segments with associated lights arranged in a diamond pattern. The user selects the direction to be indicated and plugs the light into a conventional electrical outlet. The lights on a pair of adjacent windows are illuminated to create a direction indicating arrow. For example, the lights on the upper pair of windows of the diamond are illuminated to indicate straight ahead, or the lights on the left pair of windows of the diamond are illuminated to indicate a left direction, etc.

In another embodiment, the windows and lights are arranged in an X pattern. The direction is indicated, similar to the above embodiment, by selectively energizing the lights associated with an adjacent pair of windows or leg segments of the X pattern to define the resulting arrowhead which points in the desired direction.

In a further embodiment, the face of the light is rotatable and generally opaque except it has a translucent part in the shape of an arrowhead. The face is rotated so that the arrowhead points in the select direction. A light source within the plug-in light produces light that transmits through the translucent arrowhead to indicate the direction.

The directional light may have a backup power source that energizes the light when the main power goes out. Circuitry automatically switches to the backup power source when the main power goes out. Moreover, the circuitry may make the direction indicating lights flash when on backup power.

Other objects and purposes of the invention will be apparent to persons familiar with arrangements of this general type upon reading the following specification and inspecting the accompanying drawings.

### BRIEF DESCRIPTION OF THE DRAWINGS

FIG. 1 is a schematic plan view of an office environment with a system of directional lights according to the present invention;

FIG. 2 is a perspective view of a wall panel construction with a plurality of the directional lights according to the present invention;

FIG. 3 is an enlarged perspective view of a directional light on a wall panel;

FIG. 4 is a rear elevational view of the directional light;

FIG. 5 is a cross sectional view taken generally along line 5-5 in FIG. 4;

FIG. 6 is a diagram of the control structure for a directional light;

FIG. 7 is a control circuit diagram of the directional light;

FIG. 8 is a view similar to FIG. 3 but showing a first modified plug-in directional light;

FIG. 9 is a view similar to FIG. 3 but showing a second modified plug-in directional light; and

FIG. 10 is a view similar to FIG. 3 but showing a third modified plug-in directional light.

Certain terminology will be used in the following description for convenience in reference only, and will not be limiting. For example, the words “up”, “down”, “right” and “left” will refer to directions in the drawings to which reference is made. The words “in” and “out” will refer to directions toward and away from, respectively, the geometric center of the structure and designated parts thereof. Such terminology will include the words specifically mentioned, derivatives thereof, and words of similar meaning.

### DETAILED DESCRIPTION

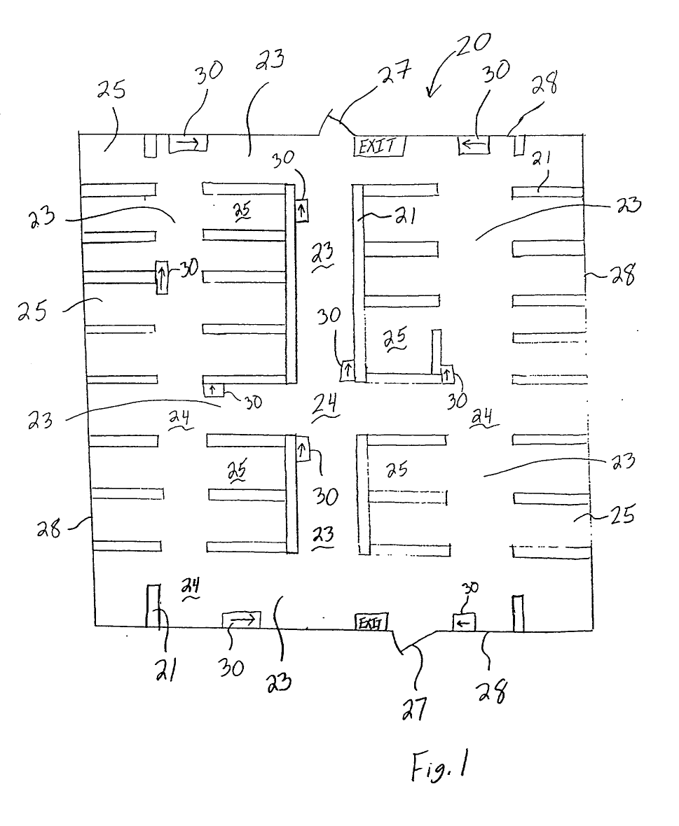

Referring to FIG. 1, there is schematically shown an office environment 20 that includes a plurality of space dividing structures, e.g. wall panels 21. Generally, wall panels 21 divide the office environment 20 into hallways or passages 23, hallway intersections 24 and work stations 25. A doorway or other exit 27 is located at each opposite end of the illustrated office environment, which doorways 27 are formed through preexisting building walls 28. A system of plug-in directional lights or indicator units 30 of the present invention is shown attached to some of the wall panels 21 and walls 28. The lights 30 are positioned in the hallways 23 and at intersections 24 and serve to indicate the direction to a select destination to thereby provide directions to office occupants which may be employees or visitors. For example, the lights 30 can point to one doorway 27 which may be the nearest emergency exit doorway or an entry to a conference room.

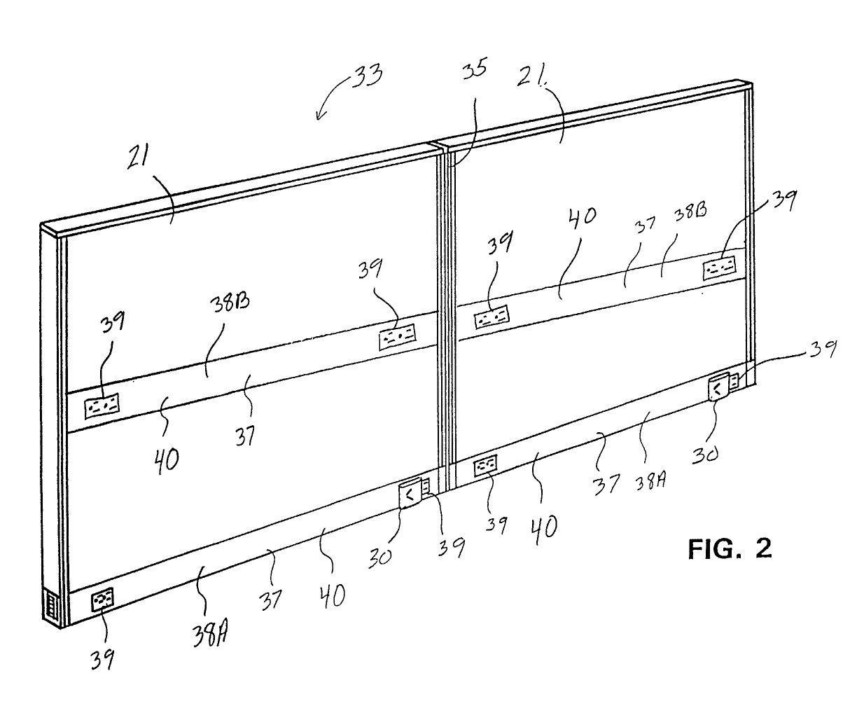

More specifically, a multiple wall panel assembly 33 is shown in FIG. 2 and has two wall panels 21 serially joined together at junction 35 in end-to-end relation. Each wall panel 21 has one or more raceways 37 which may be a base raceway 38A at the bottom thereof or a beltline raceway 38B. A raceway 37 can also be positioned at the top of the wall panels depending on the type of wall panel appropriate for the office environment. Raceways 37 provide electrical power to outlets 39, which are accessible through raceway covers 40 and are shown as three-prong, duplex outlets that allow two power plugs to be simultaneously inserted therein. As described herein, directional light 30 is inserted into an outlet 39 thereby mechanically supporting and electrically powering the light, here shown with a left direction indicator illuminated.

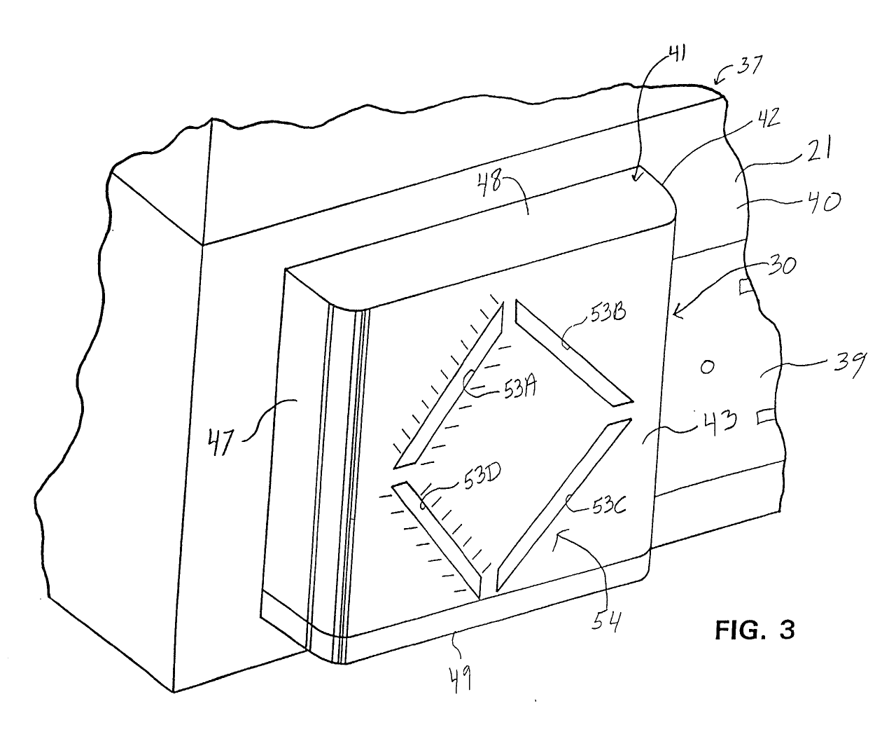

As shown in FIGS. 3-5, a preferred directional light 30 has a generally square box-like housing 41 with a front wall 43 that is remote or spaced outwardly from the wall panel 21 when the light is plugged into an outlet 39 and a rear wall 45 that is adjacent the wall panel in opposing relation therewith. The front and rear walls 43 and 45 are both generally planar and essentially parallel to each other.

Side and top walls 47 and 48 are preferably integrally formed with the front wall 43, for example molded from a plastic, to form a front housing cover 42 having a depth of about 0.75 inch and height and width of about 3.5 inches. Such compact dimensions and the light weight (less than about five pounds) of the directional light 30 allow it to be easily manually transported. A bottom wall 49 is integrally molded with the side and top walls 47 and 48 or is a cover attachable to the front cover 42.

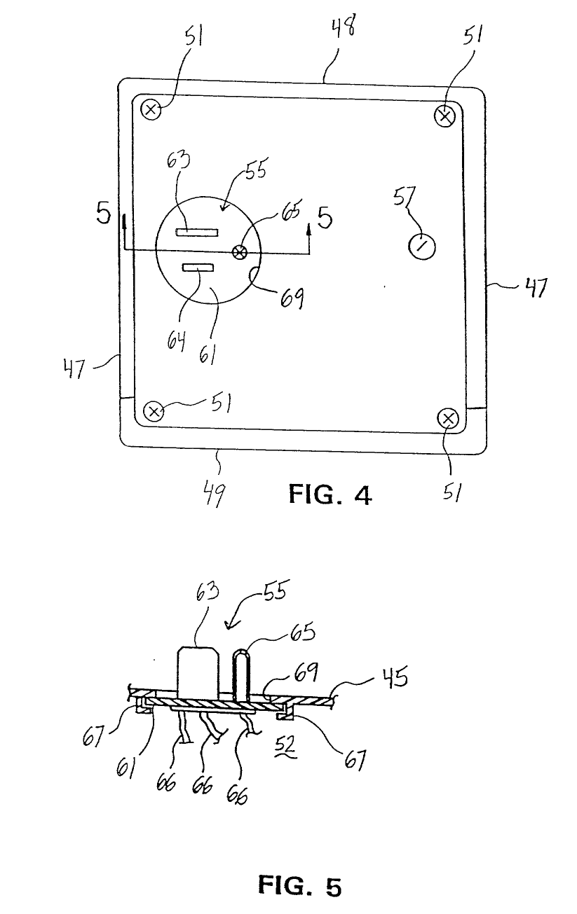

The front housing cover 42 thereby has a rearward-opening, rimmed tray-like shape. Fasteners 51 (FIG. 4) hold rear wall 45 on the front housing cover 42 to define a closed interior chamber 52 in which is mounted the associated electronics, which will be explained in greater detail below. Fasteners 51 have threads that are received in rearward-opening mounts or threaded bores formed integral with the front housing cover 42.

To indicate directions, a plurality of direction indicators 54 are provided, specifically, four elongate indicator segments, here shown as light transmitting windows 53A-53D, are arranged on the front wall 43 in the shape of a diamond and define the light transmitting areas for indicating directions. The windows 53A-53D are through voids in the front wall 43. Alternatively, the light transmitting windows 53A-53D may be translucent portions of the front wall 43 with the remainder of the front wall 43 being opaque. The side and top walls 47 and 48 are also opaque.

In one embodiment of the invention, the bottom wall 49 is at least partially translucent so that the plug-in directional light 30 will illuminate downwardly toward the floor or an adjacent worksurface. Alternatively, the bottom wall 49 may be opaque so that the only light emanating from directional light 30 is through the windows 53A-53D.

As best seen in FIGS. 4 and 5, the rear wall 45 includes an electrical power plug 55 which projects rearwardly and a recessed, indicator direction selection switch 57 which is rearwardly accessible. The power plug 55 has a disk-like base 61 to which is fixed a conventional three-prong arrangement of electrical power connecting pins 63, 64 and a ground pin 65. Each pin 63, 64, 65 is connected to internal electronics via a separate conventional wire 66. The pins 63, 64, 65 are adapted to be communally inserted into a conventional three-prong electrical outlet 39 to provide the electrical power to the directional light 30.

With this plug arrangement, the directional light 30 can be removably mounted to any existing receptacle location to provide directions to an occupant. Thus, the directional light 30 can be located in a passage 23 or intersection 24 on the closest available receptacle outlet 39. Further, the directional light 30 does not require any hardwired electrical connections, and the plug 55 additionally provides the mechanical support for the light when the plug is inserted into an outlet 39. Accordingly, the preferred directional light 30 does not require separate mechanical fasteners, brackets or the like which greatly simplifies the structure of the directional light 30 and the process of mounting the directional light 30 to a wall.

Further, the base 61 is preferably rotatably mounted between the rear wall 45 and at least two inwardly extending finger-like mounts 67 with the pins 63-65 extending rearwardly through an aperture 69 in the rear wall. Mounts 67 are fixed to the rear wall, extend into the chamber 52 and then radially inwardly bend toward the center axis of the aperture 69. Aperture 69 has a diameter less than base 61. Accordingly, the base 61 is rotatably held between the rear wall 45 and mounts 67, which allows the power plug 55 to be rotated to align with the outlet 39. The directional light 30 can be aligned with the bottom wall 49 facing downwardly when the directional light 30 is mounted to any outlet regardless of the outlet's orientation.

Also, aperture 69 is offset to one side of the rear wall so that when directional light 30 is plugged into the duplex outlet 39 it does not cover both plug-ins. As such, the directional light 30 can be oriented on duplex outlet 39 so that the directional light does not prevent access to the other plug-ins in the outlet when mounted thereon.

The indicator direction selection switch 57 is mounted to the rear wall 45 laterally aligned with and spaced from aperture 69. Switch 57 is accessible through the rear wall 45 and a user can select the directional light's indicated direction when directional light 30 is unplugged and removed from outlet 39. In this unmounted state, the rear wall is accessible to permit a user to engage switch 57 and orient same to select the direction indicated by directional light 30. When the directional light 30 is plugged into the outlet 39, the switch 57 is closely adjacent outlet 39 and wall panel 21 and inaccessible to reduce the likelihood of accidentally changing the state of the switch 57. It is understood that selection informing indicia may be placed on rear wall 45 adjacent switch 57 so that the selected direction is visually verifiable to the person moving switch 57 even though the direction indicators on the front of housing 41 are not energized.

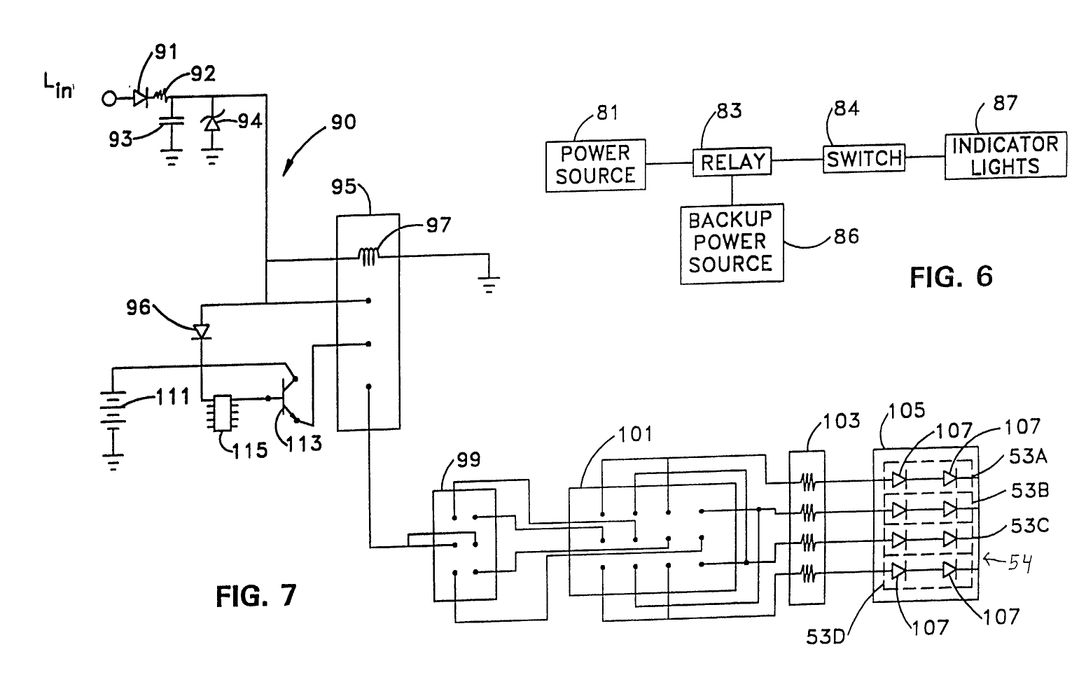

Referring now to FIG. 6, the electrical system of the directional light 30 will now be described. This system has a principal power source 81, which includes conventional AC line power from the electrical outlet 39 and rectifies the AC line power to DC power. A relay 83 receives the rectified power from the power source 81 and in its usual operating condition transmits same to switch 84. A backup power source 86 is also connected to the relay 83, and when principal power source 81 is interrupted, the relay transmits electrical power from the backup power source 86 to the switch 84. Switch 84 selectively powers indicator lights 87 so that the lights indicate the select direction.

More specifically, a control circuit 90 that selectively powers the indicator lights is shown in FIG. 7. A rectifier 91 receives the line-in electrical power, e.g. a standard U.S. 120 volt, 60 hertz power signal, and rectifies same to a DC power signal. A resister 92 is serially connected to rectifier 91. The node of resister 92 remote the rectifier is connected to capacitor 93, zenier diode 94, relay 95 and diode 96. Capacitor 93 and zenier diode 94 are connected to ground in parallel. Resister 92 and capacitor 93 act as a low pass filter for the rectified DC power signal. Zenier diode 94 regulates DC voltage.

The DC power signal energizes the coil 97 of the relay 95. The energized coil 97 connects the DC signal to the output of the relay 95, i.e. holds the normally open terminal closed. In the alternative the relay can be solid state. The relay output is connected to switch 57 which includes a double pole, double throw switch 99, which a user can position to select the two segments that indicate the select direction, and a nonshorting second switch 101, which isolates nonadjacent segments from each other for any state of switch 57 by having a separate output for each of the four states of the indicator. More specifically, switch 101 prevents the light sources respectively associated with nonadjacent light transmitting windows 53A and 53C or windows 53B and 53D from being simultaneously energized.

A resister array 103 serially connects the outputs of isolating switch 101 to the light sources in the indicator 105, and more specifically to selections of windows 53A-53D. The resisters in the resister array control the current supplied to these light sources. Each light source in the illustrated embodiment has a plurality of serially connected light emitting diodes (LED) 107, which in turn are connected to ground, that act as visual indicators when emitting light. The diodes 107 are aligned with the windows 53A-53D so that the light they produce is transmitted from the interior chamber 52 of the housing 41 through the windows 53A-53D.

The circuitry 90 selects and powers the light sources to indicate a direction using the line-in voltage. However, it is important to also indicate direction if the line-in voltage is interrupted, for example during a power failure in the building or an interruption of power service during a storm. The power could also be interrupted by a tripped circuit breaker or blown fuse if the circuit to which the directional light 30 is connected becomes overloaded. For this purpose, the circuitry 90 includes a battery 111 as a backup power source which powers the direction indicators, here LEDs 107, when the line-in voltage is interrupted. The battery 111 is connected to a collector of transistor 113. Transistor 113 acts as switch to control battery power to the LEDs 107.

A timer 115 is connected to the battery 111 and the diode 96. The timer 115 can be a conventional 555 integrated circuit timer, which triggers when the line-in voltage is interrupted. The timer 115 output is connected to the gate of transistor 113 to control the operation of transistor 111, which supplies battery power to the relay 95 and LEDs 107. The emitter of transistor 113 is connected to the normally closed terminal of the relay 95. When the line-in voltage stops, the relay coil 97 is not energized and the normally closed terminal connects to the output terminal of the relay 95. The battery now powers the LEDS through the switches 99, 101 as discussed above with regard to powering the LEDs with the line in voltage. In one embodiment, timer 115 is set to slowly intermittently open and actuate the transistor 113 so that the LEDs are intermittently powered and slowly blink.

The compact housing 41 and circuitry 90 provide a lightweight directional light 30 that is easily manually transportable and usable with any standard electrical outlet. The directional light 30 is mechanically supported on an outlet only by the plug 55 being received in the outlet 39.

In use, a person takes one directional light 30 to a location where it is desired to indicate a direction and locates the nearest outlet 39. The switch 57 is oriented to select the desired direction indicated by the indicators on the front of housing 41. The plug 57 is oriented so that bottom wall 49 is down and one plug-in of a duplex outlet 39 is not covered. The power plug 55 is now inserted into the other plug-in of outlet 39 to support directional light 30 and energize select adjacent light indicator segments, e.g. segments 53A, 53D in FIG. 3. This installation process is repeated for other lights 30 in the office so that a pathway is indicated to the desired location by the directions indicated by directional lights 30. The plug-in directional light 30 is thus easily configured to the office environment without the need for highly skilled laborers. Moreover, a plurality of lights 30 can be quickly installed in an office to indicate the select pathway through the office.

The pathway indicated by directional lights 30 can be easily changed simply by unplugging plugs 55 and turning switch 57 and reinserting plugs 55 into the same outlets 39. It is also possible to reorient the directional lights 30 themselves or use directional lights 30 in a different office space. The directional lights 30 are manually unplugged, moved to new locations and simply installed as discussed herein.

While the above described embodiment of the present invention uses LEDs 107 as the light source for indicating a direction, other devices for indicating direction on an indicator unit 30 are also within the scope of the present invention. One example is the use of a liquid crystal display (LCD) to indicate direction. The indicator unit 30 employing an LCD to indicate direction would have switch 57 that a user could operate to select the direction by activating the LCD using an appropriate control circuit so that an adjacent pair of direction indicating segments of the LCD are activated in the manner as described above with regard to the LEDs 107 to indicate the select direction.

Additional light sources include low power, miniature light bulbs and electroluminescent technology. Examples of electroluminescent technology can be found in products produced by Metromark, Inc. of Minnetonka, Minn. Once again both of these light sources have appropriate circuitry connecting the power supply to the light source and switch 57 for selecting the indicated direction which is indicated by direction indicating segments.

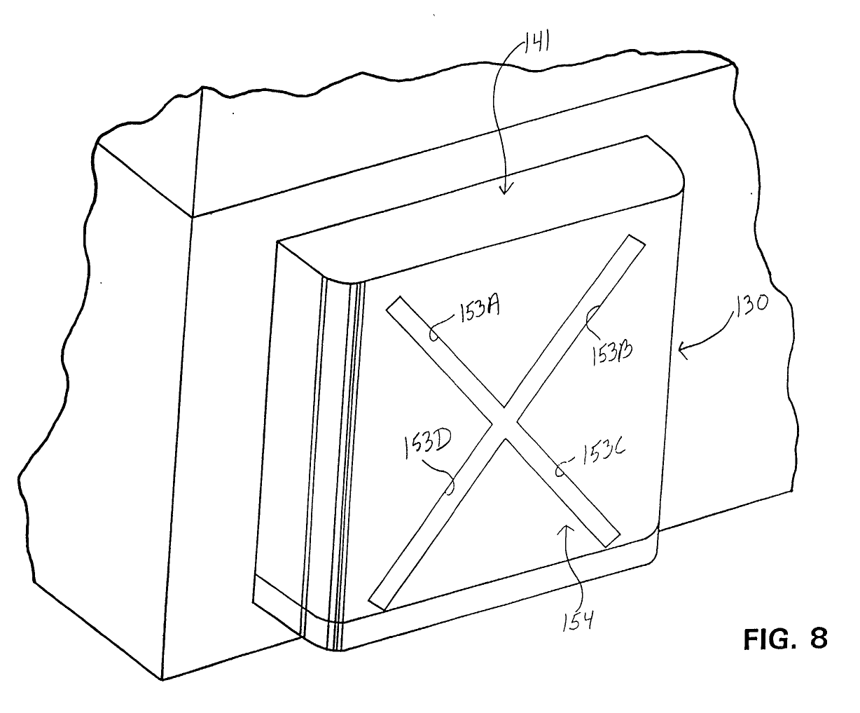

It is also within the scope of the present invention to alter the layout of the light transmitting windows 53A-53D and the associated light sources, e.g. LEDs 107, as long as the new layout can indicate a direction to a destination. Referring to FIG. 8, there is shown a modified directional light 130. Elements of the modified directional light 130 that are similar to elements described above are indicated by the same reference numerals with the prefix “1”.

The segments or windows 153A-153D are arranged in an X pattern with window 153A aligned with window 153C and window 153B aligned with window 153D. The LEDs associated with adjacent apertures 153A-153D are selectively illuminated as discussed above to indicate a direction. For example, the top adjacent windows 153A, 153B are illuminated to indicate a reverse or down direction, or the right windows 153B, 153C are illuminated to indicate a right direction, etc. This embodiment can also indicate a do not enter message by illuminating all windows 153A-153D in the X pattern.

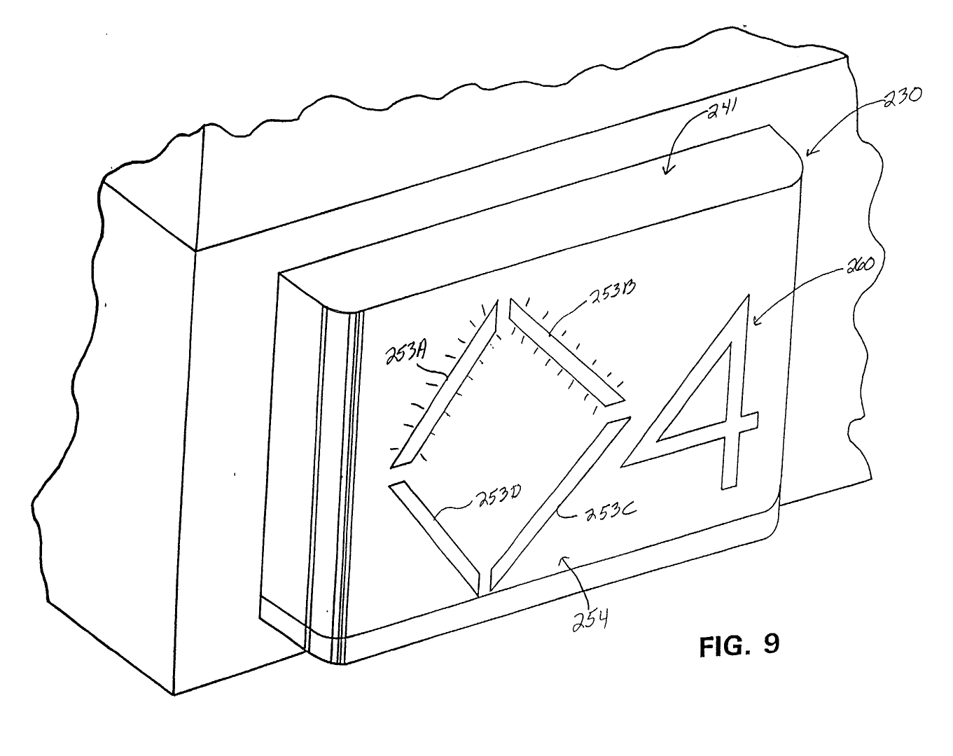

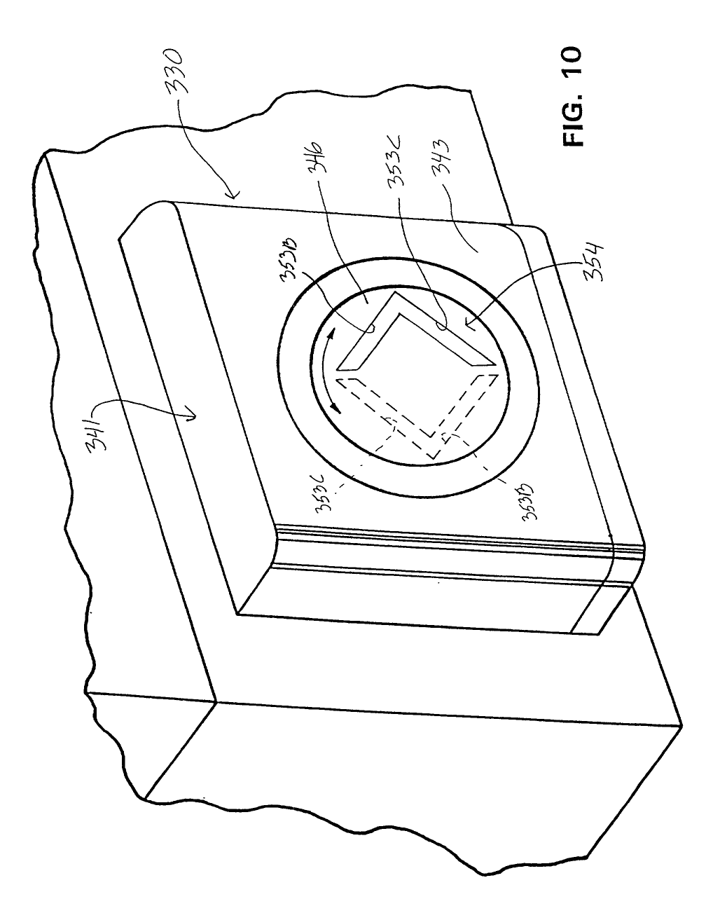

FIG. 9 shows a further modification of the above described embodiments of the inventive directional light 230, in which elements that are the same as those in the first described embodiment above are indicated by the same reference numerals with the prefix “2”.

More specifically, the directional light 230 is enlarged so that it has direction indicators, here light transmitting windows 253A-253D with associated light sources, e.g. LEDs, and an alpha-numeric indicator 260 which identifies the distance to the destination. The upper adjacent windows 253A, 253B are illuminated indicating a straight ahead direction. Indicator 260 is set to indicate the distance remaining to the indicated destination, e.g. an exit door. As shown, the directional light 230 indicates four yards (or meters) in a straight direction. The indicator 260 is set by a user accessing a control in the rear wall of the light 230. The indicator 260 may be a single or double digit display device with each digit created by indicators. These digit indicators can be created by seven or sixteen segment displays or by a LED dot matrix display, all of which are connected to a driver circuit. Indicator 260 can also be an LCD or constructed with electroluminescent technology. It is also within the scope of the present invention to display other information by replacing the indicator 260 with additional windowed displays that are suitably driven by associated circuitry to display the desired information such as text messages. For example, the indicator 260 may identify the destination as “EXIT” or “CONFERENCE ROOM”.

Another embodiment of the invention is shown in FIG. 10, wherein elements that are the same as those in the first described embodiment are referenced by the same reference numerals with the prefix “3”.

Directional light 330 has housing 341 with an opaque front wall 343. A direction indicating face 346 is rotatably mounted centrally to front wall 343. Face 346 has two directional indicating segments, have light transmitting windows 353B and 353C, which define a single direction indicator 354 and can be apertures in the face or transparent portions with the remainder of the face being opaque, forming a direction indicating arrowhead. The windows 353B and 353C on face 346 as shown in solid line indicate right. When it is desired to indicate a different direction, face 346 is rotated to another position with the direction indicator 359 indicating the desired direction. An example of another possible position of windows 353B, 353C is shown in broken line and indicates left. While the direction indicator 354 is defined by segments or windows 353B or 353C, the direction indicator 354 may also be a single three-sided triangle or other shape which is generally recognized as a pointer to indicate a direction.

The face 346 and front wall 343 may have cooperating structure to hold the windows 353B, 353C in the selected direction and yield upon application of a force to the face. One structure for holding the face in the select direction is a set screw operating between the face 346 and front wall 343, with the set screw loosened the face can turn relative to the front wall and with the set screw tightened the face can not rotate. Another structure for holding the face 346 relative to the front wall 343 is a cooperating protrusion and receiving recess structure that engages in each of the positions of the face, e.g. up, down, right and left. Such a protrusion and recess structure would yield upon application of a manual force so the face would be adjusted to the desired direction. Another structure for holding the face relative to the front wall is a friction engagement between the face and front wall that holds the face on the front wall yet allows the face to rotate when a force, usually a manual force, is applied thereto. Moreover, directional light 330 with the rotating face 346 can indicate any direction in its 360 degree rotation.

In operation, a system of directional lights 30 are provided wherein the directional lights 30 can be inserted into outlets 39 to indicate direction as discussed herein. The lights 30 are plugged into conventional outlets 39 and thus can be retrofitted to preexisting offices which include wall panels 21 and fixed walls 28. It will be understood that while wall panels 21 are disclosed herein to subdivide an office space, the wall panels 21 alternatively may be fixed walls, such as stud walls which define a similar arrangement of passages 23 and intersections 24 as illustrated in FIG. 1.

A plurality of directional lights 30 thereby defines a direction indicating light system usable in combination with space-dividing walls. Moreover, the directions indicated by directional lights 30 can be changed if the destination changes. For example, the lights 30 can be used to indicate the desired pathway through the wall panels 21 of a divided office space. If the wall panel configuration or destination is changed, the lights 30 are easily reconfigured to indicate a new pathway. The directional lights 30 can be moved to new outlets and/or the directions indicated by the light can be changed simply by adjusting switch 57. For example, if the positions of the wall panels changes, then the pathways and intersections will change. There is a need to indicate desired travel pathways to a destination in this new wall panel configuration. Each directional light 30 is set to indicate a direction from a receptacle 29 to the destination by positioning switch 57 and is then plugged into the receptacle. This procedure thereby will indicate the pathway from the position of select directional light 30 to the destination.

Additionally, the indicator units 30 may be further modified. For example, the indicators on the indicator units 30 may be symbols other than arrows. Further, while the indicators are lighted in the illustrated embodiments, the indicators may be nonilluminated.

As discussed herein, the indicator units 30 preferably use visual indicators, it also may be desirable to use audible indicators either alone or in combination with the visual indicators.

It also is within the scope of the invention to use different color indicators to form different systems of indicator units 30 which are used simultaneously in the same office area. For example, a plurality of indicator units 30 having green indicator lights might be used to identify an exit, while orange indicator units 30 are used in the same passages to identify a conference room. Each indicator unit 30 could have a preset color or could have multiple colors wherein the color is adjusted or set during installation.

Although particular preferred embodiments of the invention have been disclosed in detail for illustrative purposes, it will be recognized that variations or modifications of the disclosed apparatus, including the rearrangement of parts, lie within the scope of the present invention.

What is claimed is:

1. A directional light for indicating a select direction in an office space and adapted to be plugged into a standard electrical outlet, comprising:
a housing having front and rear walls, said front wall having at least one direction indicator thereon for indicating a plurality of directions;
an electrical plug mounted to said rear wall and adapted to be inserted into an electrical outlet; and
a control circuit mounted to said housing and electrically connected to said plug, said control circuit powering said direction indicator so that said direction indicator is energized to indicate a selected one of said directions.

2. The directional light according to claim 1, wherein said control circuit includes a light source mounted to said housing and associated with said direction indicator and said control circuit powers said light source to provide illumination to said direction indicator.

3. The directional light according to claim 2, wherein said direction indicator is defined by a plurality of direction indicating windows in said front wall and said light source including light producing devices respectively aligned with said windows.

4. The directional light according to claim 3, wherein said light source is a plurality of LEDs, with at least one said LED being aligned with each said window, said LEDs aligned with an adjacent pair of said windows simultaneously emitting light to indicate a select direction.

5. The directional light according to claim 3, wherein said windows are translucent portions of said front wall and the remainder of said front wall is opaque so that light emitted by said light source is only transmitted through said front wall through said translucent portions, and said light producing devices are respectively aligned with said translucent portions.

6. The directional light according to claim 2, wherein said control circuit includes a backup power source and, when the principal power received by said plug is interrupted, said control circuit automatically switches to said backup power source to power said light source to continue to indicate the selected direction.

7. The directional light according to claim 6, wherein said control circuit includes a timer and a backup power supply switch to intermittently supply backup power to said light source indicating the selected direction so that said light source blinks when on backup power.

8. The directional light according to claim 1, wherein said plug is mounted to said rear wall and includes connecting pins extending rearwardly from said rear wall, said connecting pins being rigidly supported on said rear wall so that said connection pins are able to rigidly support said directional light on an outlet.

9. The directional light according to claim 8, wherein said rear wall has an aperture therein and inwardly extending mounts positioned around the periphery of said aperture, and said plug includes a base with a diameter greater than said aperture and positioned inwardly of said rear wall, said base being rotatably held adjacent said rear wall by said mounts.

10. The directional light according to claim 9, wherein said housing has a side wall extending between said front and rear walls, and said plug is mounted to said rear wall adjacent said side wall so that when said plug is received in one plug-in receptacle of a duplex outlet, the other plug-in receptacle of the outlet can still receive other plugs.

11. The directional light according to claim 1, wherein said plug is the only support holding said housing on a wall when said plug is engaged with an outlet.

12. The directional light according to claim 1, wherein said control circuit has a control switch accessible through said rear wall with said plug removed from an electrical outlet, said control switch being selectively positioned so as to control said direction indicator to change said direction being indicated.

13. The directional light according to claim 2, wherein said housing includes an at least partially transparent bottom wall which allows light from said light source to transmit through said bottom wall.

14. The directional light according to claim 1, wherein said direction indicator is rotatably mounted on said front wall, said direction indicator being rotated so that said direction indicator identifies one of said plurality of directions.

15. In an office space having a plurality of walls which divide the office space into a plurality of work areas, passageways which connect said work areas to each other, and passageway intersections which connect a plurality of passageways together, said walls having a plurality of electrical outlets which are accessible along said passageways and said office space further including at least one door providing access to a destination, the improvement comprising a system of directional indicator units which direct an occupant to said destination, each of said directional indicator units having a housing with front and rear faces, said front face having at least one visible direction indicator thereon which is changeable to indicate a plurality of different directions;
said direction indicator having a light source which illuminates said indicator such that said indicator when illuminated is visible from an exterior of said housing to identify a selected one of said plurality of directions;
an adjustment device which is manually actuable to change said direction being identified by said indicator; and
an electrical connector which is connected to said light source to provide power thereto, said electrical connector being removably engagable with a selected one of said outlets so that said directional indicator unit is positioned on and electrically connected to any one of said outlets, said adjustment device being actuated so that said indicator identifies said selected direction and said system of said directional indicator unit directs an occupant through said passages and/or intersections to reach said destination.

16. The indicator unit system according to claim 15, wherein said indicators identify a left direction, a right direction and a straight direction.

17. The indicator unit system according to claim 16, wherein said indicators are arrows which point in directions corresponding to said left, right and straight directions.

18. The indicator unit system according to claim 15, wherein said walls are defined by a system of space-dividing wall panels, said wall panels being connected in end-to-end relation to define said work spaces, said passages and said intersections.

19. The indicator unit system according to claim 18, wherein said wall panels are removably engaged with each other to permit rearrangement of said wall panels to rearrange said work spaces, said passages and said intersections, said indicator unit being disengageable from said outlets to permit repositioning of said direction lights depending upon the arrangement of said wall panels.

20. The indicator unit system according to claim 17, wherein a plurality of said indicators are provided and said adjustment device selectively illuminates at least one of said indicators to indicate the direction from this said indicator unit to said destination.

21. A directional light for indicating a select direction in an office space and adapted to be plugged into an electrical outlet, comprising:
a housing having a direction indicator thereon for indicating a plurality of directions;
an electrical plug mounted to said rear wall and having a prong arrangement adapted to be inserted into an electrical outlet; and
a control circuit mounted to said housing and electrically connected to said plug, said control circuit powering said direction indicator so that said direction indicator is energized to indicate a selected one of said directions, said control circuit including a light producing device associated with said direction indicator wherein said control circuit powers said light producing device to provide illumination to said direction indicator, and said control circuit having a control switch which is selectively actuatable so as to control said direction indicator to change said direction being indicated.

22. The directional light according to claim 21, wherein said direction indicator is defined by a plurality of direction indicating displays in said housing and said light producing device selectively providing light to said displays.

23. The directional light according to claim 22, wherein said displays comprises a plurality of LEDs, with at least one said LED corresponding to each said display, said LEDs corresponding to an adjacent pair of said displays simultaneously emitting light to indicate a selected direction.

24. The directional light according to claim 21, wherein said control circuit includes a backup power source and, when the principal power received by said plug is interrupted, said control circuit automatically switches to said backup power source to power said light producing device to continue to indicate the selected direction.

25. The directional light according to claim 21, wherein said plug is the only support holding said housing on a wall when said plug is engaged with an outlet.

26. In an office space having a plurality of walls which divide the office space into a plurality of work areas, passageways which connect said work areas to each other, and passageway intersections which connect a plurality of passageways together, said walls having a plurality of electrical outlets which are accessible along said passageways and said office space further including at least one portal providing access to a destination, the improvement comprising a system of directional indicator units which direct an occupant to said destination, each of said directional indicator units having a housing and at least one illuminated direction indicator thereon which is changeable to indicate a plurality of different directions and is connected to an adjustment device, said adjustment device being manually actuable to change said direction being identified by said indicator wherein said direction indicator is visible from an exterior of said directional indicator unit to identify a selected one of said plurality of directions;
said directional indicator unit further including an electrical connector which is connected to said light source to provide power thereto, said electrical connector being accessible from an exterior of said housing and removably engagable with a selected one of said outlets so that said directional indicator unit is positioned on and electrically connected to any one of said outlets, said adjustment device being actuated so that said indicator identifies said selected direction, said directional indicator units of said system being distributed along said passageways to visually direct an occupant through said passages and/or intersections to reach said destination.

27. The indicator unit system according to claim 26, wherein said indicators at least identify a left direction, a right direction and a straight direction.

28. The indicator unit system according to claim 26, wherein said walls are defined by a system of space-dividing wall panels, said wall panels being connected in end-to-end relation to define said work spaces, said passages and said intersections.

29. The indicator unit system according to claim 28, wherein said wall panels are removably engaged with each other to permit rearrangement of said wall panels to rearrange said work spaces, said passages and said intersections, said indicator unit being disengageable from said outlets to permit repositioning of said direction lights depending upon the arrangement of said wall panels.
